(19) United States
(12) Patent Application Publication
(10) Pub. No.: US 2003/0037170 A1
(43) Pub. Date: Feb. 20, 2003

(54) House communication network

(76) Inventors: Markus Zeller, Diedorf (DE); Mike Heidrich, Muenchen (DE); Rainer Steffen, Muenchen (DE)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/071,005

(22) PCT Filed: Aug. 10, 2000
(86) PCT No.: PCT/EP00/07799

(30) Foreign Application Priority Data
Aug. 13, 1999 (DE) 19938354.5

(51) Int. Cl. G06F 15/16

(52) U.S. Cl. 709/253; 709/250

(57) ABSTRACT

A communication system for a house, a flat or an office in a house or for separated blocks of buildings, so as to connect at least three terminal units within said house, flat, office or separated blocks of buildings, is based on a central data bus for transmitting data to be transmitted between the terminal units, wherein the data bus has no specific deterministic access control and a limited transmission capacity. A first intelligent network terminating device is provided in the first terminal unit and includes interfaces for communication devices which may be located in the first terminal unit. A second intelligent network terminating device is located in the second terminal unit and includes interfaces for communication devices which can be located in the second terminal unit. Each intelligent network terminating device includes an interface which is responsible for quality of service control located between the data bus and the corresponding network terminating device and which is embodied such that an access of the corresponding network terminating device to the central data bus will be controlled. The communication network permits an integration of all of the communication and house services via the central data bus and is characterised by its flexibility, clear layout and its favourable price.

### FIELD OF THE INVENTION

The present invention relates to house communication systems for a house, flat or office in a house or for interrelated separated blocks of buildings and, in particular, to a communication system by way of which the most various communication devices which are applicable in a house can communicate via one single data-bus.

### BACKGROUND OF THE INVENTION AND PRIOR ART

In general, the following scenario exists at the moment. In a high-rise building, there are, for example 10 flats and/or offices. The high-rise building further includes a central heating and a wind/solar-detection system in order to close the blinds upon appropriate solar radiation and to open the blinds again when the wind is too strong, at least on the first few floors. The house further includes a lift as well as, under certain circumstances, a video camera for monitoring the entrance area, an emergency-call function in order to alert the doorman of the house and a reception from where one can obtain information from a receptionist about the companies resident in the house. In each of the offices in the high-rise building, there is a computer network and a telephone system. Both the computer networks in the offices and the inhabitants in the private flats in the high-rise building have at least, in part, access to the Internet and diverse multimedia consumer devices. Eventually, there could still be a specific internal telephone system as well as, if the companies are associated companies, an audio and video system in order to distribute audio and/or video data in the house.

Seen from the standpoint of installation, several separate communication systems and/or cable harnesses exist for this house in the cable shaft of the house. The first communication system is the telephone system. Usually, each office has its own ISDN switching system.

A further communication network is provided to perform the wind/sun control of the blinds in addition to further house services, such as e.g. heating detection and heating control responding to the former. Another specific communication system for the house includes the door intercom system and/or the door-opening system. A person who is responsible for the information service at the reception communicates, by way of an extended door intercom system, to the corresponding company and/or the corresponding private person that visitors are on the way. A specific cable network should exist for the video detection of the entrance area, which normally should be feasible from each office and/or each flat since the network for the door intercom system is typically much too narrow-banded for transferring audio and/or video data. If this network for the video-monitoring service has been selected to be broad-banded enough, a house-specific broadcast/video network might be integrated in this network.

Otherwise, a specific broad-banded broadcast or multicast network will be required for this purpose as well.

Usually, one can only access the ISDN switching station existent in the house from the external communication network, which is currently, for the most part, a ISDN network; but there is no access to the other communication networks located in the house, which were discussed above.

An adverse effect of the scenario discussed above is the fact that a multiplicity of specific communication systems in the house, which are mostly separated from one another, require a multiplicity of cable harnesses to be located in the cable shaft. Assuming that a system is installed separately from one another, these cable harnesses will create a considerable amount of confusion one day, in particular, if tenants have moved flats quite often and, therefore, changes have been made. Then, there is actually nobody who has kept track of the cable harnesses in the house and their association with the communication systems.

Another disadvantage is that it is virtually not possible for the individual networks to work together among themselves in an orderly kind of way, which is also referred to as inter-working, and that all networks implement their service separately from one another. Again, this requires further complicated and expensive installations in the house, if, for example, the heating and/or other house services or maybe the lift in the house are not to be controlled and/or maintained locally by a resident caretaker, but on a central basis by means of data-control.

A further disadvantage of the described scenario is that, in principle, the same terminal devices exist for many separate applications. For example, there is a multiplicity of telephones in each office, e.g. for the telephone system of the office and, in addition, for the door intercom system, which are similar in function.

In addition to its inflexibility and confusing nature, the described scenario is further characterised in that it is altogether very expensive, since there is a multiplicity of terminal devices which, as has been described, actually work in the same way, and, especially when one thinks of larger buildings, there is a multiplicity of cables which, owing to their specific material values and, apart from that, owing to their installation costs, have considerable significance in terms of costs.

DE 196 34 778 A1 discloses a telephone system with a video camera which, via a central means, is connected to an integrated services digital network (ISDN). The means includes an audio unit for coupling a door intercom system to the digital network, a video unit for coupling the video signals of the video camera to the digital network, a control unit for transmitting a request signal for establishing a switched connection for transmitting the video and audio signals via the digital network in case the door intercom system has been actuated, in addition to receiving control signals and for transmitting the control signals without interruption of the switch connection to at least one remote-controllable unit and an ISDN video telephone with programmed call diversion.

Thus, an integration of door communication and video monitoring of the entrance area with an ISDN network available in an office is given. What is disadvantageous about this system is the fact that no solution for the house in general is given, i.e. for all the flats and/or offices, and that specific installations are yet required for all the other communication networks described. The ISDN network is further limited in its capacity and functionality owing to the ISDN protocol which has not been designed for a house communication system.

### SUMMARY OF THE INVENTION

The object of the present invention is to provide an inexpensive communication network for a house, a flat or an office in a house or for interrelated separated blocks of buildings, which is characterised by good use of service and transparency on the one hand and flexibility with respect to user requirements and extensibility on the other. In accordance with the present invention, this object is achieved by Communication network for a house, a flat or an office in a house or for separated blocks of buildings, so as to connect at least three terminal units within the house, the flat, the office or the separated blocks of buildings, comprising: a central data bus for transmitting data to be transmitted between at least the said three terminal units; a first network terminating device which is provided for a first terminal unit and which comprises interfaces for communication devices which may be disposed in the first terminal unit; a first interface which is allocated to said first network terminating device and which is disposed between the central data bus and the first network terminating device and which is designed for controlling an access of the first network terminating device to the central data bus; a second network terminating device, which is provided for a second terminal unit and which comprises interfaces for communication devices which may be disposed in the second terminal unit; a second interface which is allocated to the second network terminating device and which is disposed between the data bus and the second network terminating device and which is designed for controlling an access of the second network terminating device to the central data bus; a third network terminating device which is provided for a third terminal unit and which comprises interfaces for communication devices which may be disposed in the third terminal unit; a third interface which is allocated to the third network terminating device and which is disposed between the central data bus and the third network terminating device and which is designed for controlling an access to the third network terminating device on the central data bus, wherein the central data bus is a jointly utilised transmission path which may be accessed by the first, second or third network terminating device without considering other network terminating devices, wherein said first, second and third interfaces are arranged for controlling said access to the first, second and third network terminating device on the central data bus such that guaranteed transmission parameters are guaranteed for a communication between the first, the second and the third network terminating device via the central data bus, and wherein each network terminating device or each communication device connected to the network terminating device is formed so as to arrange, together with the interface means which has been allocated to the same, transmission parameters for a transmission via the central data bus for achieving an adaptive service quality.

The present invention is based on the recognition that a uniform communication system for a house can only be achieved by dividing the house into sub-groups which may be, for example, distinct flats or offices. In view of interrelated campus-like blocks of buildings, which are arranged in a distributed manner and which consists of various buildings, but which are centrally managed, a division into sub-groups, for example, into certain building sections can be implemented as well. Alternatively, a flat can also be sub-divided in sub-groups, so that, for example, each floor and/or each room forms a specific and independent sub-group.

The architecture of the inventive communication system provides a specific network terminating device for each sub-group, which may also be referred to as a terminal unit, by way of which all communication devices existing in the terminal unit or subgroup can be connected via corresponding interfaces existing in the network terminating device.

Each network terminating device is connected to the physical data bus by a specific interface means, which may be implemented, for example, as a shielded twisted two-wire line, a non-shielded twisted two-wire line, an optical fibre line or any other suitable medium.

A data transmission protocol exists for the data bus, which comprises no deterministic access control. In other words, the transmission protocol of the data bus is designed such that the data bus is used as a shared medium such that each subscriber may access the data bus regardless of the other subscribers, and that, if, owing to the limited data transmission capacity, there is not sufficient capacity at hand, data would go lost and could no longer be transmitted according to their requirements.

According to the invention, the interface means associated with each network terminating device is designed as a QoS-interface (QoS=Quality of Service) such that access to the network terminating devices and, thus, access to the communication devices connected to the network terminating devices will not take place on the data bus in an uncontrolled manner, but will take place such that a fair allocation of a band width to the single subscribers can take place without data losses and, thus, application requirements can be fulfilled.

This allocation preferably takes place such that the communication devices connected to the network terminating devices, which transmit or receive voice data or video data, are preferred to communication devices which only effect data transmission. Thus, it is irrelevant as to whether data for controlling a house with respect to central heating or blinds obtain are a larger delay, while such a larger delay or delay should not be tolerable for telephone or video applications.

It is preferred that the network terminating devices are designed such that they enable an inter-working, i.e. co-operating of the various communication devices connected to them and located in a terminal unit, e.g. an office, without loading the central data bus in the house with data transmissions.

Owing to its low price, great availability and further owing to the low price of all the pertaining components, the Ethernet protocol in accordance with standard IEEE 802.3 is preferred as protocol for the central data bus. It has turned out that, owing to its low price and flexibility, which exhibits itself in the great scalability from 10 to 1000 Mbit/s, the Ethernet transport platform for house communication systems is especially suitable, if this transport platform, which is equipped as a shared medium in accordance with the standards and which this does not include any deterministic access control in common applications and which is usually wired in a star-shaped manner, is provided with an interface means for each network terminating device, which performs the said access control.

The inclusion of typical house services, such as door and house communication, safety functions, building control functions, monitoring services, specialised applications, such as concierge, can be carried out easily and upgraded without the slightest modification to the cable shaft.

It is preferred to design a network terminating device as a central communication server which enables a link to the external data network via a narrow-banded or broad-banded access system (such as, for example, ISDN, xDSL, Powerline, optical fibre , etc.). In contrast to a single link of each flat and each office, respectively, a concentrating link is achieved which is made inexpensive due to the fact the multiplex gain can be utilized and that there is only one central switching centre which can be used by all subscribers together without offending the independence of individual subscribers. It is, in particular, this independence of individual companies in one house that especially effects the failure of a common ISDN system for all offices in this house, as this would require arrangements to be made between offices.

According to the invention, a network terminating device for each office will be provided such that each office can continue enjoying its independence from the other office. Furthermore, a central communication server will be provided, which provides a concentrating input and a concentrating output, respectively, to the external data network without being relevant in any way for the offices. This will become more relevant, especially when other telecommunication providers are taken into consideration who have to pay rent for the said communication services. In the scenario described at the beginning, where a specific telecommunication system exists for each office, only one single transmission line is required for the telecommunication-like supply of the entire high-rise building and, so that rent has to be paid only to the corresponding network operator for one single transmission line—in contrast to a multiplicity of transmission lines. In particular, with bigger blocks of buildings, this will lead to significant cost-savings.

What is finally advantageous about the inventive system is that, for example, for centrally controlling several houses via the central communication server in each house, various house functions can be controlled from outside without the need of an assembler having to be available on site. This fulfils the requirements on flexibility and should be preferred under cost aspects. Preferred embodiments of the present invention will be discussed in detail below with reference to the attached drawings.

### BRIEF DESCRIPTION OF THE DRAWINGS

FIG. 1 is a general representation of the inventive communication system in a house;

FIG. 2 is a principle representation of the inventive communication system with a central communication and information server with an access to an external network;

FIG. 3 is a detailed representation of an intelligent network terminating device including an interface means for said access control and a network terminating device;

FIG. 4 is a detailed representation of the intelligent network terminating device from FIG. 3;

FIG. 5 is a general representation of the central data bus in the overall system;

FIG. 6 is a representation of the protocol stack of the inventive transport platform including said central data bus in addition to said interface means for each network terminating device;

FIG. 7 is a principle representation of the inventive communication system with a multiplicity of network terminating devices which are connected to the central data bus via hubs or which are connected to a secondary branch which, in turn, is connected to the central data bus via a hub;

FIG. 8 is a principle representation for dividing the central data bus into two token-passing systems which are connected to each other via a gateway (GW);

FIG. 9 is a principle representation of a connection of the central data bus, in which a token passing architecture is implemented, to a LAN (LAN =Local Area Network) via a gateway, which is arranged in a network terminating device;

FIG. 10 is a logical general representation of the connection of two token passing systems via a LAN;

FIG. 11 is an alternative implementation of the central data bus using two master/slave networks and a gateway;

FIG. 12 is a principle representation of the connection of two master/slave networks via a gateway within which the respective master units are integrated;

FIG. 13 is a representation of the inventive communication system using the ISO/OSI model.

### DETAILED DESCRIPTION OF THE PREFERRED EMBODIMENT

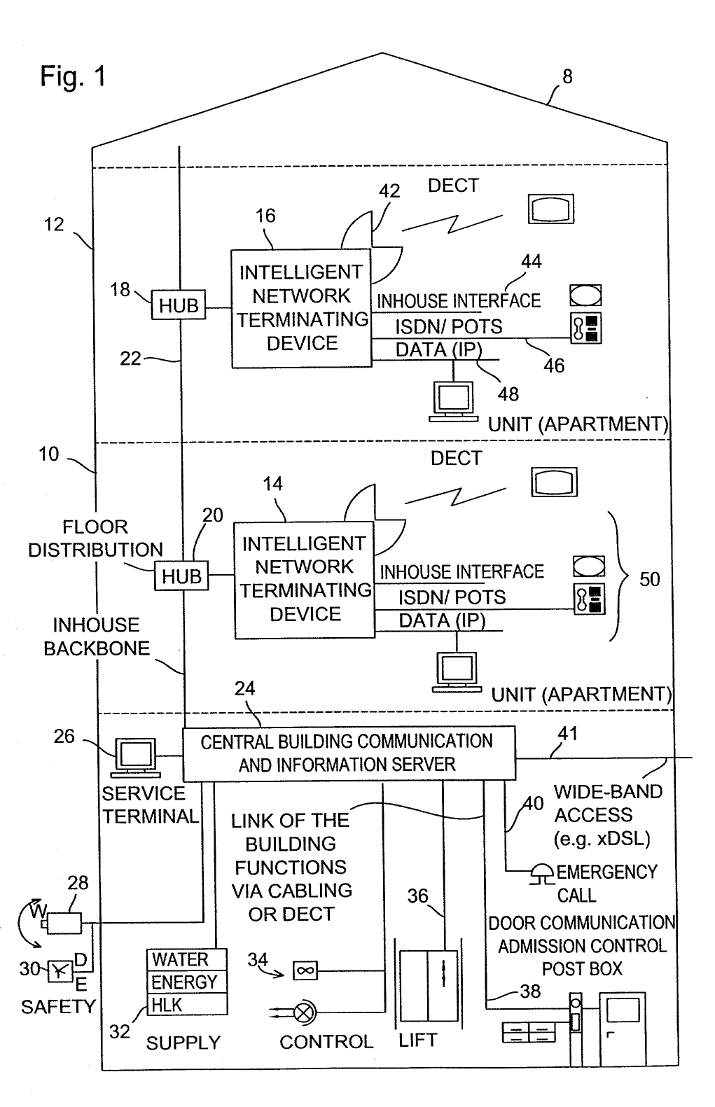

FIG. 1 shows an overview of the inventive communication system for a house, consisting of two terminal units, e.g., flats, 10 and 12 in the example shown in FIG. 1. A first intelligent network terminating device 14 is located in the first flat. A second intelligent network terminating device 16 is located in the second terminal unit 12. Said both intelligent network terminating devices are connected via respective hubs 18, 20 to a central data bus which, in turn, is in contact with a central building communication and information server 24.

In the embodiment shown in FIG. 1, the central building communication and information server is implemented as a specific element. According to the invention, it has the following functionalities.

At first, a realisation of switching services is to be achieved. Thus, the server can perform the switching of telephone calls. The switching can take place within the communication system, thus, from one subscriber (connected to one device) to another subscriber (connected to another device), or via the server to the outside, to the public telephone networks. The switching services are similar to those of a telephone system. Here, data in the form of IP or other data packages are switched as well. Here, it is also preferred that a subscriber exchanges data via the server with another subscriber. In this case, the server undertakes the switching, i.e. the routing of the data.

Furthermore, the server serves for realising administration services, i.e. services 10 which are necessary for managing a building. This may be, e.g., the recording of telephone charges of telephone calls, data connections, the electricity bill, etc., or also the monitoring of accesses to services and the distribution of access rights.

Furthermore, the server serves for processing building-specific services. These services include, e.g., door services, safety and monitoring services, HLK (HLK=Heizung, Lüftung, Klimatisierung =heating, ventilation, air condition) or lift control.

Furthermore, the server can also perform the de-multiplex/multiplex function for the external connection. In the case of telephone services, the telephone connections from the public network are distributed among the individual subscribers. Generally, less telephone connections than subscribers are needed since statistics state that there is no likelihood that all subscribers are on the telephone at the same time. The more subscribers connected to the communication system, the greater is the multiplex gain (total number of subscribers)/ (number of required telephone lines).

In data transmission, the broad-banded connection, e.g., xDSL or optical fibre, is distributed among the individual subscribers according to their respective demand.

In general, the communication and information server is an extended intelligent network terminating device. However, when compared to the network terminating device, it has the described special tasks, such as the management tasks or the broad-banded linking of the communication system to the access network. The server thus operates on a building-specific basis, while the network terminating device is designed according to a unit-specific basis.

All functionalities of the communication and information server may also be integrated within the first intelligent network terminating device 14 or within the second intelligent network terminating device 16. For practical reasons, it is preferred to provide a specific central building communication and information server for house 8, which is accommodated in a specific room of the house, for example, in the basement or in a study of a caretaker's flat, which may also be located in the house. Preferably, there is furthermore a service terminal 26 in this room via which the inventive communication system is controlled, changed, supplemented or maintained in a general sense. The central building communication and information server 24 is connected to a video camera 28 as well as, optionally, to further sensors, 30 for monitoring the safety of the house 8. The central server 24 is further arranged to carry out supply tasks with respect to water, energy and HLK 32. Furthermore, the central server is connected for controlling the air conditioning system of the house in addition to further functions, for example, controlling the blinds, etc., which are generally characterised by the symbols indicated at 34 in FIG. 1. With respect to lift control 36, door communication, access control and post-box monitoring 38 or emergency call function 40 of the building, the central server further has the task of alerting the guard personnel from each flat 10, 12. It should be noted that door communication, access control and postbox monitoring may either be connected by means of cables or may also be implemented in a wireless manner, for example, by way of a DECT radio link (DECT=Digital Enhanced Cordless Telephone).

The central building communication and information server 24 further provides a broad-banded access which can be implemented, for example, by way of xDSL (DSL=Digital Subscriber Line; x is a character for a certain technology and for a certain method, respectively, where “A” would stand for asymmetrical and “S” for symmetrical) to increase the data transmission band-width on standard telephone cables. As has already been explained, a specific intelligent network terminating device exists for each terminal unit. On the output side, the latter contains, for example, a DECT interface 42 for a wireless telephone system or a data transmission system in the terminal unit 12, an in-house interface 44 for the heating control, control of the blinds, etc., in the corresponding terminal unit 12, an interface 46 for an ISDN telephone system or POTS telephone system (POTS =Plain 10d Telephone Services) which exists in the corresponding terminal unit, in addition to a data interface which may, for example, be designed in accordance with the Internet protocol to provide access to the Internet from the flat 12 via the intelligent network terminating device 16, the hub 18, the central data bus 22, the central server 24 and the broad-band access interface 41.

As has already been noted, all functionalities of the central building communication and information server 24 may alternatively be integrated within the intelligent network terminating device 14. Then, the inventive communication system would only consist of the two intelligent network terminating devices 14 and 16 which are connected to each other via the central data bus 22. If the entire communication system only has two intelligent network terminating devices, the central data bus can be connected direct to the central data bus without using the hubs 18, 20. If, however, as shown in FIG. 1, a specific central building communication and information server 24 is provided which fulfils the functionalities shown in the lower section of FIG. 1., the intelligent network terminating devices for the hubs 18, 20 have to be connected to the server 24. In this case, the central building communication and information server may also be extended by the functionalities of the intelligent network terminating devices 14, 16 as required, so that there is a communication system which practically has three intelligent network terminating devices, 14, 16 and 24.

Although the embodiment of the present invention shown in FIG. 1 relates to a house 8 with two flats 10, 12, the inventive system may easily be applied to a house with offices only or to a house with offices and private flats. The inventive communication system may, however, be applied to one flat only, so that the individual rooms form the terminal units, such that there is a specific inventive communication system for one flat, with the intelligent network terminating devices being arranged in the individual rooms of the flat, for example.

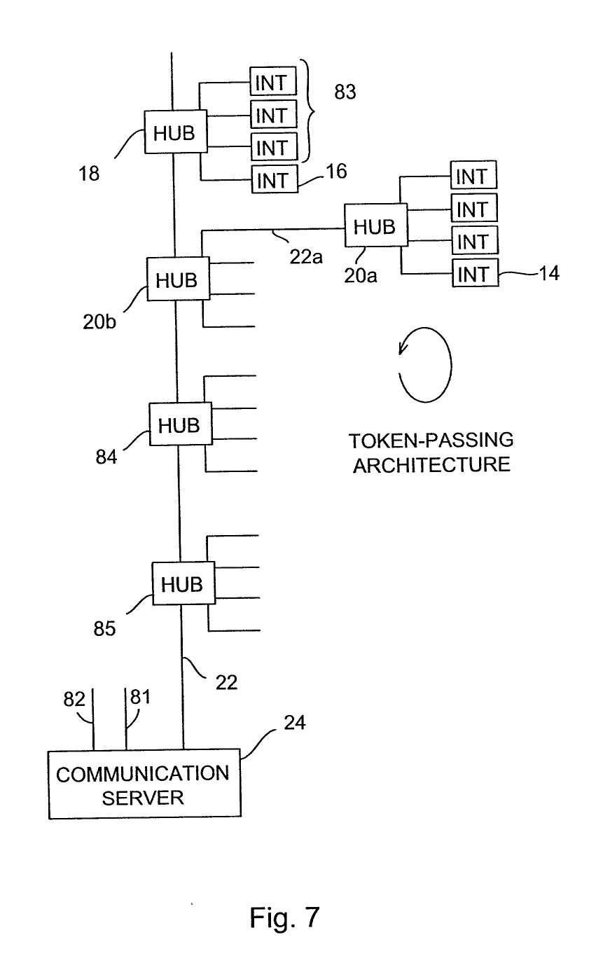

Furthermore, it should be appreciated that the inventive communication system is not limited to being employed in a house only. It can also be employed in somehow interrelated, separated blocks of buildings. Such interrelated , separated blocks of buildings could be a campus, for example, consisting of University buildings and residential buildings. Employing the inventive communication system in such interrelated separated blocks of buildings makes sense if the blocks of buildings are, for example, under a common management. The inventive communication system may also be employed for industrial enterprises which include several buildings. In this case, a central building communication and information server 24 would be located in the central office of the building block management. Each individual building, i.e. northern building, southern building, main building, etc., would then comprise a specific intelligent network terminating device connected to the central data bus via a hub. The individual storeys of the northern building, for example, would then be connected to the intelligent network terminating device of the northern building, as implied in FIG. 7, so that a network branching has been achieved which comprises a northern building communication network for which an intelligent network terminating device of the northern building works as a central server, while this central server, in turn, is connected to the central server of the entire block of buildings. Therefore, a hierarchic structure can be obtained in accordance with the invention. Alternatively, it is, of course, possible to share equal rights among all of the intelligent network terminating devices independent of the architectural circumstances. The actual implementation will depend upon whether a large volume of data traffic takes place within a building or whether this internal data traffic is less significant compared to the data traffic going via the central server for the entire building complex.

It is further appreciated that the individual parts of the separated blocks of buildings do not have to be located in immediate vicinity to one another. They may also be located apart from each other, as there must only be a branch from the central data bus to the distant part of the block of buildings. Should the distances grow larger, repeaters have to be employed, as is known in the art, to regenerate the transmitted digital signal at distances established by cable attenuation. Especially in such cases of application with a multiplicity of intelligent network terminating devices, the advantageous aspect of the inventive concept turns out here, since much time and money is spent installing new data lines between buildings located apart from each other and since low-cost components, in particular, in large quantities, i.e. a lot of cable, a large number of repeaters and hubs, may indeed result in a high price of the total system, such that the inventive communication system has an enormous competitive advantage when compared to system solutions dealing with a multiplicity of networks which operate in parallel and are designed on an application-specific basis.

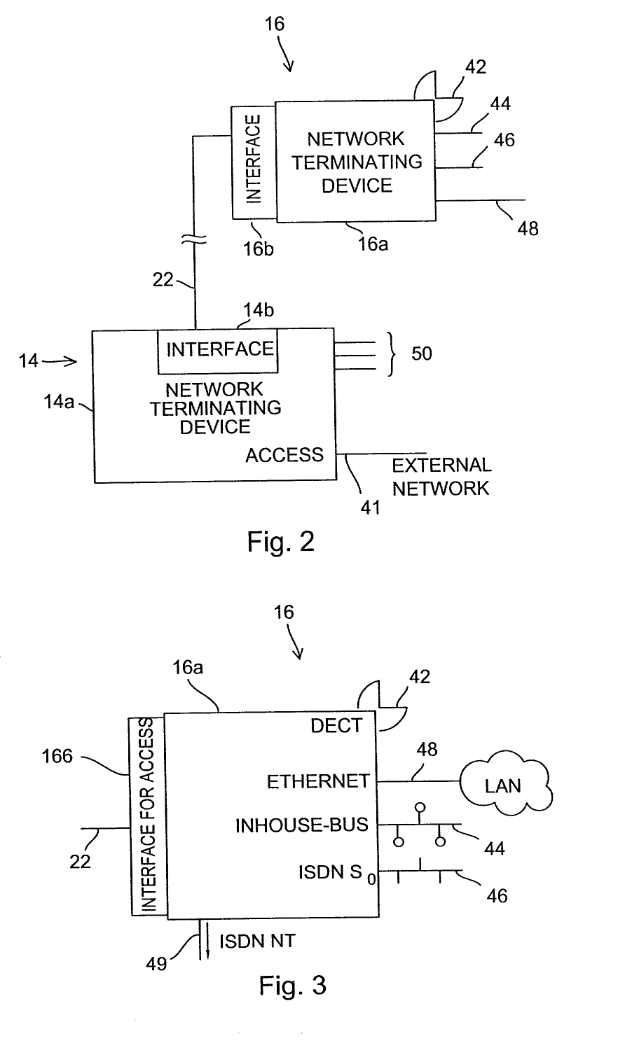

FIG. 2. shows a principle sketch of the inventive communication network. As has already been explained, the inventive communication network includes the central data bus 22 and the first intelligent network terminating device consisting of a network terminating device 14a in addition to an interface means 14b. The same applies to the second network terminating device which also consists of a network terminating device 16a and an interface means 16b. The central data bus is not connected direct to the network terminating device, but via the respective interface means. The interface means 14b, 16b are designed to control the access of the respective network terminating device to the central data bus which does not include any deterministic access control and typically has a limited transmission capacity. On the “output side” (if the part of the network terminating device connected to the associated interface is regarded as an input) the network terminating devices include various interfaces, which, for the first network terminating device 16a, are referred to as 42, 44, 46, 48, which represent the functionalities shown in FIG. 1. The network terminating device 14a, 14b also includes a number of interfaces 50 which, in principle, may correspond to the interfaces 42 to 48, with the first network terminating device 14 from FIG. 2 providing the special feature of this network terminating device also having has an interface 41 to the external network. The first network terminating device 14 in FIG. 2 has thus been extended by functionalities of the central server 24 from FIG. 1 and may, therefore, also include terminals 26 to 40 of FIG. 1.

The second network terminating device 16 thus serves as an interface for communication systems within a terminal unit (flat/room/office). The intelligent network terminating device consisting of the network terminating device 16a and the interface 16b, therefore, integrates standardised and customary interfaces, e.g., for DECT, voice and telecommunication applications, Internet and data services in addition to inhouse bus systems, such as, for example, EIB (EIB=European Installation Bus =bus technology for a building automation, which is most popular in Europe), and also enables an optional inter-working between the individual interfaces. The network terminating device itself may, therefore, also be operated as a so-called stand-alone apparatus within a unit, e.g., an office. In addition, it provides an interface to the central data bus via the interface means (e.g., 16b), which links the network terminating device to the other network terminating device and provides access to the house commumcation.

The central data bus 22, which is preferably based on Ethernet, which has been extended to be a QoS-capable transmission protocol by means of the interface means 14b, 16n, may be designed as an un-shielded twisted two-wire line, as a shielded twisted two-wire line, as an optical fibre cable or as any other medium on the physical level. Although, in principle, various transmission methods/transport protocols may be used for the present invention, and which are suitable for a central data bus, such that they do not comprise any specific deterministic access control, i.e. all subscribers have the same rights and access the system as desired, and have a limited data capacity, preference is given to the Ethernet owing to its low price, flexibility, great popularity and its high degree of technical sophistication. Thus, all the following explanations refer to the preferred embodiment of the present invention in which the central data bus is an Ethernet data bus in accordance with standard IEEE 802.3.

In the inventive communication network shown in FIG. 2, the first network terminating device 14 is extended to be a communication and information server. Thus, the first network terminating device 14a provides the connecting member between the in-house network and the access network which multiplexes or processes the various data streams on a service-specific basis, respectively. Optionally, switching of the varying data using PBX functions (PBX=Private Branch Exchange) is also possible. At the same time, an inter-working on a network and application level between the various networks/services is realised here. Furthermore, information about various in-house services are provided. In its basic functionality, the first network terminating device thus corresponds to the second network terminating device and server services for the inventive communication network can still be realised in part, for example, when a central QoS management of the interface means, switching services or multiplex services are employed.

In the following, a more detailed explanation of the first and the second interface means (14b, 16b) of the first and second network terminating devices (14a, 16a), respectively, will be given. Each of these interface means (14b, 16b) may be configured essentially the same and is also referred to as QoS layer. Such an interface means assumes the control of the media access. This assumption of the interface means guarantees that the connected station can transmit only at certain times which have been allocated to the same and/or only a limited amount of data. This inventive control of media access guarantees that collisions are prevented, i.e. that two or more stations can transmit at the same time, and that, due to this fact, no data loss may occur.

Furthermore, this deterministic and controlled access makes it possible to calculate the traffic of the total network and of the individual subscribers in advance. As it is possible to calculate for how long and when a subscriber is allowed to transmit, defined quality can be provided to the subscribers by way of this interface means. The following quality agreements are given preference:

Broad-band reservation. Each subscriber has a minimum-defined band-width.

Delay times. The data waiting for transmission are transmitted within a defined period of time.

Periodic transmission. In cyclic intervals, the subscribers are given the right to transmit a defined amount of data. This is, for example, preferred in voice and video transmissions.

Jitter (variation of delay). The periodic transmission is performed in regular intervals. The maximum time delay of intervals is described using maximum jitter.

Admission control. It is possible to examine beforehand as to whether newly requested quality agreements are observed. If this is not the case, this agreement cannot be accepted and/or this or an already existing agreement must be put into a lower category in order to accept the new agreement.

For each connection a new quality can be determined. The parameters for a connection include, among others: minimum band-width, maximum delay, time intervals, maximum jitter. It should be appreciated that, for a connection of the two interface means concerned, not all of the specified parameters, but at least only one, have to be established.

In FIG. 3, an intelligent network terminating device is shown which, again, consists of the interface 16b for access and of the network terminating device 16a, which includes the interfaces 42, 44, 46, 48 represented as examples in FIG. 3, and which includes optical inter-working units not shown in FIG. 3, such that traffic via the DECT interface 42 to the LAN, which is connected to the Ethernet interface of the network terminating device 16a, does not have to pass via the central data bus 22, but is dealt with, so to say, on a regional basis in the network terminating device 16a. In highly inexpensive designs such inter-working units can be omitted such that traffic is always passed via the central data bus 22.

However, it is preferred that the network terminating device 16a can also operate in the stand-alone mode such that an inter-working and mapping between DECT, Ethernet, in-house bus and ISDN is possible. On the other hand, it is further preferred to provide a further interface 49 which serves for direct connection to the ISDN network.

The following is a detailed description of the ISDN interface which may be provided at an intelligent network terminating device. If the network terminating device is connected to the communication and information server, the ISDN connection will be conducted via the QoS back-bone, which may also be referred to as tunnelling. The ISDN interface in the network terminating device thereby operates in the NT mode and feeds the terminal devices. The ISDN interface in the server operates in the TE mode and is connected to a switching unit. The ISDN connection from the INT is continuously passed to the switching unit and will not be terminated on its way. The system operates as a so-called “S₀ extension”.

If, however, the network terminating device is not connected to a communication and information server, but works as a stand-alone apparatus, the network terminating device uses the ISDN interface as an access to the telephone network. It is possible to make telephone calls and to transmit data via this access.

An intelligent network terminating device can further comprise an EIB/LON interface (LON=Local Operating Network). In a EIB/LON connection, serial data are translated into raw EIB/LON data in an EIB/LON interface library. An EIB/LON service library enables access to the interface library and, at the same time, to a TCP/IP driver and performs the networking process between the two of them. Below the TCP/IP driver, different networks may be located, such as, for example, the interface to the QoS back-bone in order to transport the EIB/LON data between the server and the network terminating device, a DECT interface or an Ethernet interface.

Consequently, an EIB access is performed the following way. The data from the EIB network are converted into serial data via an EIB serial gateway. Subsequently, the serial data are fed into the transmission network. This may be, for example, the QoS back-bone or the data interface of DECT or the conventional Ethernet. The corresponding communication partner receives the data and can forward them to a module for visualisation and control (e.g., a Webpad, Notebook, Organiser). This module can then return the control data on the same way to the EIB network.

The Internet data (IP data) can be conducted via the QoS back-bone. A further interface (QoS data) enables access to the QoS back-bone using other data formats.

Video data are tunnelled via the QoS back-bone after being received from a video card or from a network. On the distant end station, the data are re-fed into the video card and/or into another network.

In a DECT interface of a network terminating device the the DECT voice data are converted into ISDN data. Then they are treated the same way as in ISDN. With respect to general data, a conversion into the TCP/IP format is performed. The data are then treated as is usual in IP traffic.

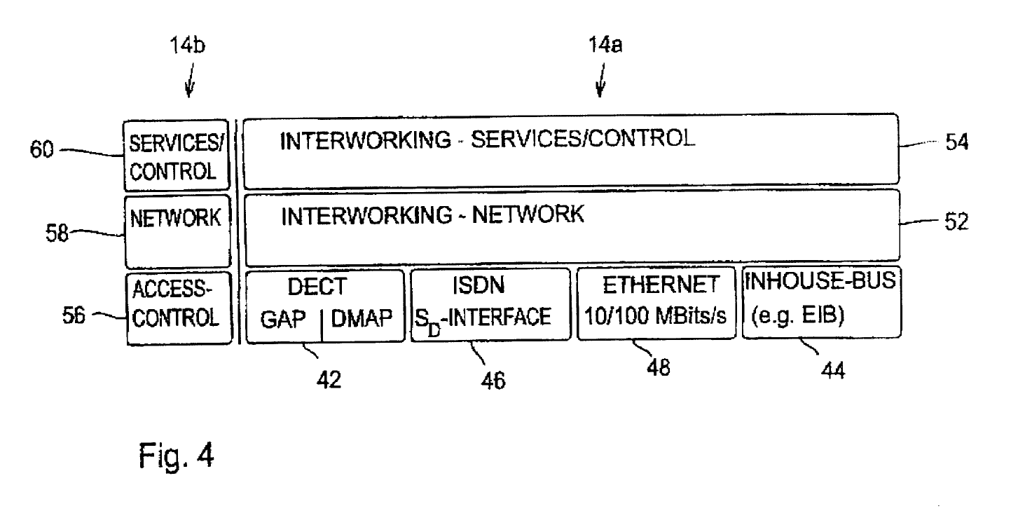

FIG. 4 shows a detailed representation of the various layers of the network terminating device 14a including the interface means 14b. On the lowest level, the interfaces 42, 46, 48 and 44 are located which were designated in more detail in FIG. 4. On the next level, an inter-working network 52 is located which enables direct traffic between the individual interfaces 42, 46, 48, 44. Above, there is a layer designated as interworking-services/control 54.

In addition, the interface means 14b comprises an analogue configuration and, as a core element, includes the access control, which performs the QoS management and which is designated with 56. Above it, there is also a network layer 58 as well as a services/control layer 60 in the interface means 14b.

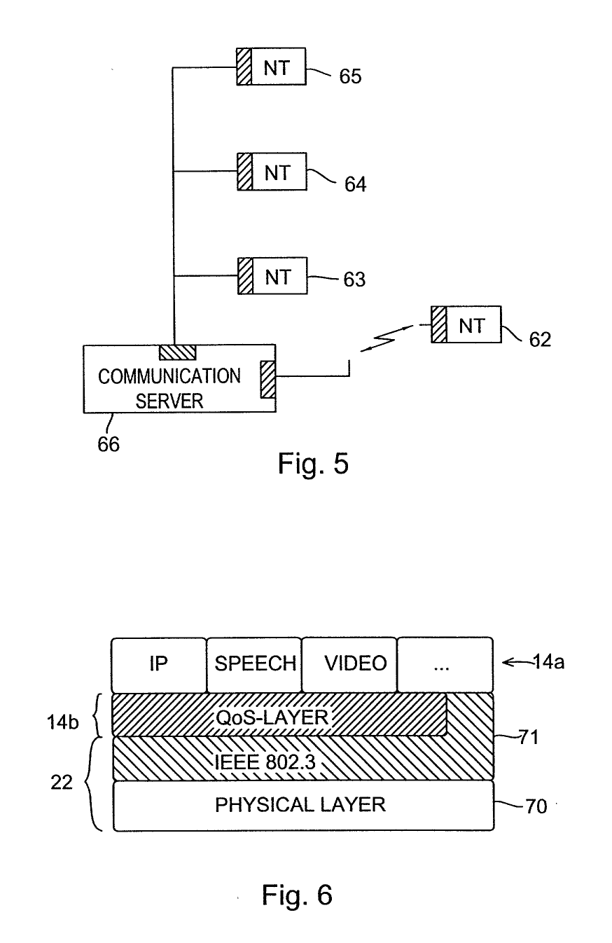

FIG. 5 shows a schematic overview of the central data bus for a system of four network terminating devices 62 to 65 in addition to a communication server 66. FIG. 5 shows the case in which the communication server 66 can serve two communication networks, namely the first communication network consisting of communication server 46 and the network terminating devices (NT) 63, 64, 65, in addition to a further communication network which merely consists of the communication server 66 and the network terminating device 62. FIG. 5 further shows that the central data bus must not necessarily exhibit a transmission line configuration, but may also have a wireless configuration. The central data bus is therefore not limited to a special physical medium. In principle, it could, thus, also be implemented on the basis of the mains or other cable systems located in the house.

FIG. 6 shows the protocol stack of the transport platform of the inventive communication network. The lowest layer, which is designated as the physical layer 70 in FIG. 6, represents the physical medium of the central data bus which either may be a transmission line, a wireless connection or an optical fibre connection. Above it, there is the transport protocol layer 71, which, in the preferred embodiment of the present invention, is designed as Ethernet transport protocol in accordance with the standard IEEE 802.3. The access of the network terminating device 14a to the transport protocol layer 71 is effected via the QoS layer 14b.

As several users have access to the transport system, the QoS layer controls the access to the central data bus 22 so that each subscriber has sufficient network capacity at his/her disposal. The requirements vary with the services used. Voice services, for example, require a short delay, which is as constant as possible, and a guaranteed bandwidth. On the other hand, keeping to a minimum delay is less important for data traffic (WWW; WWW=World Wide Web; FTP; FTP=File Transfer Protocol). Here, the user wishes a fair or assured allocation of the band-width.

The interface means 14b thus prefers communication devices connected to certain interfaces in the terminal unit of the house in contrast to other communication devices of the terminal unit of the house. Clearly spoken, it is not acceptable for a telephone service that too large delays occur, since telephone communications as they used to be are no longer possible. If, however, during transmission, data get lost when making a telephone call, this does not immediately lead to the loss of communication. On the other hand, when transmitting data of, e.g. a file, it is decisive that no data loss occurs. Therefore, it is less important for data transmission to take place in almost no time.

Such a classification can be made for all house services so that, for example, an emergency call is always given high priority, while it is not relevant for the blinds control or the heating control if the data for these systems are transmitted a few seconds sooner or later.

Thus, the required system resources are allocated to the individual services by the interface means 14b. Even if, with hard-wired point-to-point-connections, the resource allocation is relatively clearly arranged, the same, however, will be very complex in the more complicated case of several distributed units accessing to a common medium. For this, various implementation possibilities exist as to how the QoS control for such a system can be implemented. Depending on the case of application, master-slave structures, a distributed QoS management or simple prioritisations are taken into consideration. The approaches differ in their performance capability, efficiency, protocol overhead, etc.

Various building types ranging from the detached house over a multi-storey residential/office building to blocks of buildings require different networking solutions. Here, it would be sensible for the network topology and the employed transmission medium to be adaptable to the requirements.

Further, the inventive communication network has to be protected from unauthorised access. For this reason, suitable cryptographic methods may be used optionally both on the level of the interface means and on a higher level ranging up to the application to make a data corruption or an interception of data impossible, i.e. to impede the same.

Finally, the availability of the central data bus for some services, such as, for example, emergency calls, is very important. Therefore, attention should be paid to the fact that even under worst case conditions, functionality will be maintained. On the other hand, however, it is not possible to provide an unlimited data capacity for the central bus in order to reduce prices.

Since the inventive communication network is made of the separately optimisable components, such as the data bus without specific access control, the network terminating device and the interface means for adapting the corresponding terminating device to the data bus and for controlling the access to the central data bus, the inventive communication network can be scaled and adapted optimally for each case of application, be it in terms of selection of the medium for the central bus or that a network terminating device has an interworking capability or not.

In accordance with a preferred embodiment of the present invention, a decentralised selection procedure (e.g., token passing architecture) is given preference to a centralised selection procedure (e.g., master-slave procedure) owing to its superior failure safety. In the token-passing procedure, which is schematically implied in FIG. 7, a token runs from an intelligent network terminating device to the next intelligent network terminating device. Each intelligent network terminating device, provided it is in possession of the token, can transmit data on the central data bus. The functionality of token reception and of passing the token is performed by the interface means which has been assigned to the corresponding network terminating device. The interface means further establishes the amount of data each network terminating device may convey per token possessed, or rather, if a network terminating device may transmit with each token it possesses or only with each tenth token it possesses, for example.

The employed selection procedure has the advantage that it is a deterministic procedure, that a band-width reservation can be guaranteed, that maximum latency times can be guaranteed, that it is suitable for an isochronous transmission, that it offers little complexity and, especially, that it is more reliable in selection since it is configured in a decentralised manner.

The disadvantages of the decentralised selection procedure include an overhead by the passing of the token, a limited, yet variable delay, the fact that the stations which have nothing to transmit receive a token all the same or may temporarily be eliminated from the logical ring, which may result into a jitter, that it is especially suitable for an isochronous transmission and is not suitable for burst transmissions and that there is a complicated token management for regenerating, for example, a lost token.

Centralised selection procedures which, owing to a certain susceptibility to failures, are not preferred, in general, but which may prove useful in certain applications, may be designed as a master-slave architecture. Similarly, as with IEEE 802.11 (PCF; or 100VG-AnyLAN=100 Mbits/s LAN over any Voice grade cable=100 Mbits per second over any category 3 telephone line (CAT3) which was originally provided for voice transmission (Voice Grade); also known under the Standard IEEE 802.12 Demand Priority Access Method=deterministic access protocol for LANs), a master could address the stations one after the other or grant them their rights for transmission. What is advantageous about the centralised selection procedure is that it is a deterministic procedure, that a band-width reservation can be guaranteed, that latency times can be guaranteed, that it is very flexible depending on the scheduling algorithm, and that any QoS agreement can be guaranteed.

What is disadvantageous about the centralised selection procedure is that there exists an overhead as result of the stations being queried one after the other, that this procedure can become very complex depending on the scheduling algorithm, that it is consumes a lot of computing time considering that thousands of queries may take place per second, that it is at risk to experience a failure and the whole network becomes blocked in the case of overload or failure of the scheduler.

Once again, the following refers to FIG. 7. It can be seen in FIG. 7 that a communication server, as has already been represented by FIG. 5, may not only be part of one single communication network, but also part of one or several further communication networks 81, 82. Furthermore, another possible design of the inventive communication network can be seen in FIG. 7. Thus, it is represented in FIG. 7 that further intelligent network terminating devices 83 may be attached to the hub 18 to which the second intelligent network terminating device (INT) 16 is connected. In FIG. 7, the hub designated with 20 in FIG. 1 divides in a first hub 20b and a second hub 20a, with the intelligent network terminating device 14 being connected via these two hubs 20a, 20b and a secondary branch 22a, which is also part of the central data bus 22, to the communication server 24 via further hubs 84, 85.

At the terminals of the hubs 20b, 84 and 85, which are drawn in their unoccupied state in FIG. 7, either directly intelligent network terminating devices can be provided or further secondary branches can be located which, for example, may lead to other building parts of separated blocks of buildings.

The token procedure as a decentralised selection procedure provides regulated access with a token. It has a completely decentralised configuration. Alternatively, the token cycle may also be computed and controlled from a central station, for example, from the communication server. No collisions exist. The expansion of the network is only limited by damping properties. If the lines are much too long, use can be made of either repeaters or hubs, which are actually no analogue amplifiers but regenerate the binary signals. The restriction of the cable length due to damping thus exists in the case shown in FIG. 7 only with branch lines between two hubs, such as, for example, the branch line 22a or the line between the hub 18 and the hub 20b, etc.

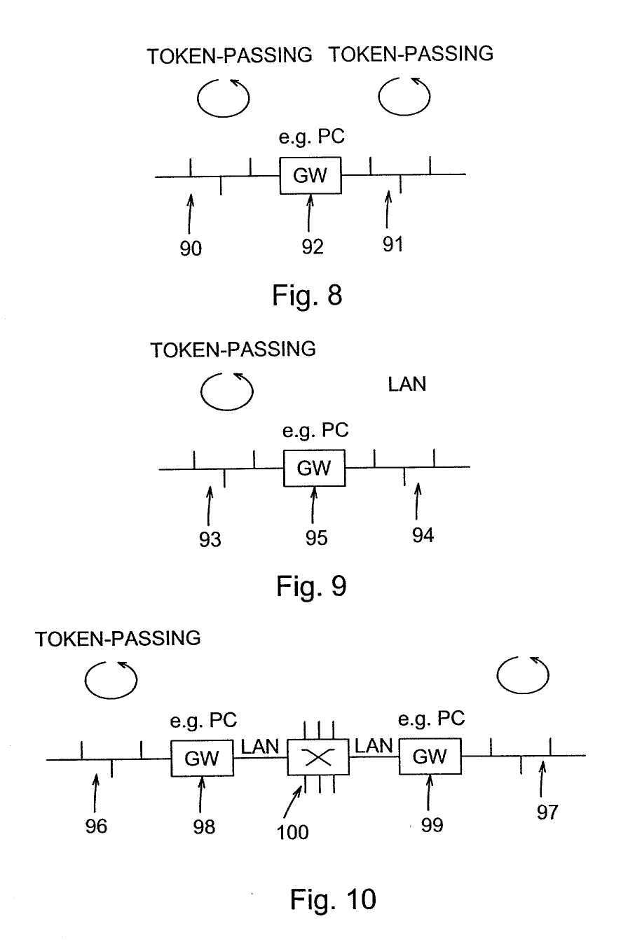

Referring to FIGS. 8 to 12, the various transitions between two networks with different or identical network architecture are dealt with. The transition from a token-passing architecture 90 to another token-passing architecture 91 is shown schematically in FIG. 8. Token-passing describes a group of protocols working according to a similar procedure. The expression “token-passing” declares nothing about the performance capability of a procedure, but merely refers to a procedure in which a token is passed to grant a transmission right. Representatives of the token-passing procedure include token bus, token ring, FDDI (Fibre Distributed Data Interface=access procedure for optical fibre lines—double ring) or Rether.

The connecting member is referred to as a gateway 92. The gateway could, for example, be a personnel computer. Such a transition could exist in an intelligent network terminating device which connects two token-passing networks located in the flat 10 (FIG. 1). Looking at FIG. 10, such a transition, however, could also exist between hub 20b and hub 18 to divide the central data bus into bus sub-structures. This is of advantage if a relatively great volume of data traffic takes place within a bus substructure, but if, however, a relatively small traffic volume takes place between the bus sub-structures. Then, each segment, i.e. the network 90 and the network 91, forms a specific, so-called domain, so that the full band-width is available for a traffic within the two domains. A transition between two networks, which is designated in FIG. 8, could also exist in the communication server 24 of FIG. 7, so as to connect the communication network 81, which is also connected to the communication server 24, to the inventive communication network, which is based on the central data bus 22. The gateway 22 may consist of a standard PC, which is equipped with two network cards. In the case of a less intensive traffic volume, which expresses itself in some computing time for the gateway 92, the gateway 92 can also take part in traffic as a normal station. However, danger exists if the gateway 92 breaks down.

FIG. 9 shows a transition between a token-passing network 93 and a LAN 94. The transition between the networks 93 and 94, in turn, is managed by a gateway 95, which may also be designed as a PC. Such a gateway 95 will be provided in each intelligent network terminating device, so as to couple a local network, for example, in an office, with the central data bus 22, which is designed as a token bus system.

FIG. 10 shows the connection of two token-passing systems 96, 97 via one gateway 98, 99, respectively, with a LAN 100. Such a structure could, for example, be located in the central communication server 24 of FIG. 7, if the communication network 81, 82 is also designed as a token-passing network, but the communication server 24 on his part, takes part in a LAN.

While, as has been explained, for the inventive house communication system, a de-centralised selection procedure is also preferred, so as to guarantee a higher failure safety, master-slave systems may also be employed in certain applications. Here, a master allocates the required system resources to the network terminating devices by granting the individual network terminating devices the right to transmit. A network terminating device may transmit only if it has just been requested by the master to do so. Each segment 101, 102 forms a specific domain, so that the full band-width is available for each segment. The gateway 103 in FIG. 11 works as a slave and assumes the forwarding job between the network segments 101 and 102. The masters 104, 105 are installed independent of the gateway in the networks 101 and 102, respectively. The gateway may consist of a standard PC, may be implemented in an intelligent network terminating device, or may be a stand-alone apparatus with two network interfaces being required. In case of a less intensive traffic volume, this gateway can take part in the master-slave procedure as a normal station. However, there is the danger of non-availability of a network segment or rather the entire traffic between 101 and 102, when the gateway 103 breaks down.

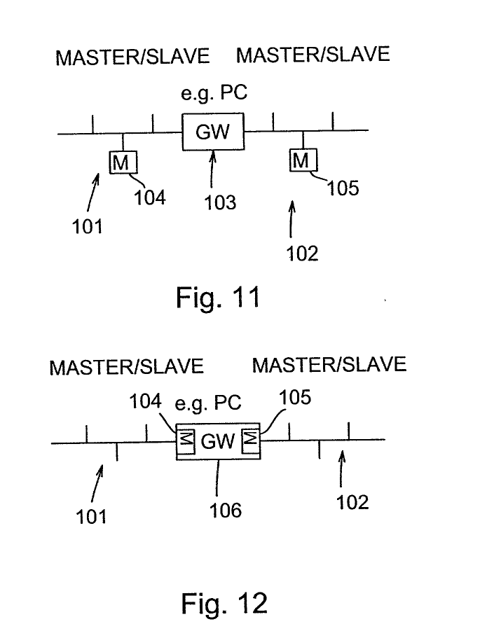

FIG. 12 shows a gateway 106 between two master-slave systems 101, 102 with the two master elements 104, 105 now being directly integrated within gateway 106. Here, the full band-width is available in each sub-network.

The following section deals once again with the communication and information server 24 (FIG. 7, FIG. 1), which serves for interfacing the total system to the external access network and which, moreover, is provided for linking the network to the individual building-specific units for building control and building monitoring. The server serves as a concentrator within the separated system from which central management and control of house communication and house services will be effected. The service and management platform of the communication server serves for illustrating and managing the building-specific services and communication and information systems. The services are implemented on the communication and information server as well as on the intelligent network terminating devices in a distributed way. For transmission, the service and management platform is seated on the transport system. Service-specific interworking between the various networks also happens on the level of the service platform.

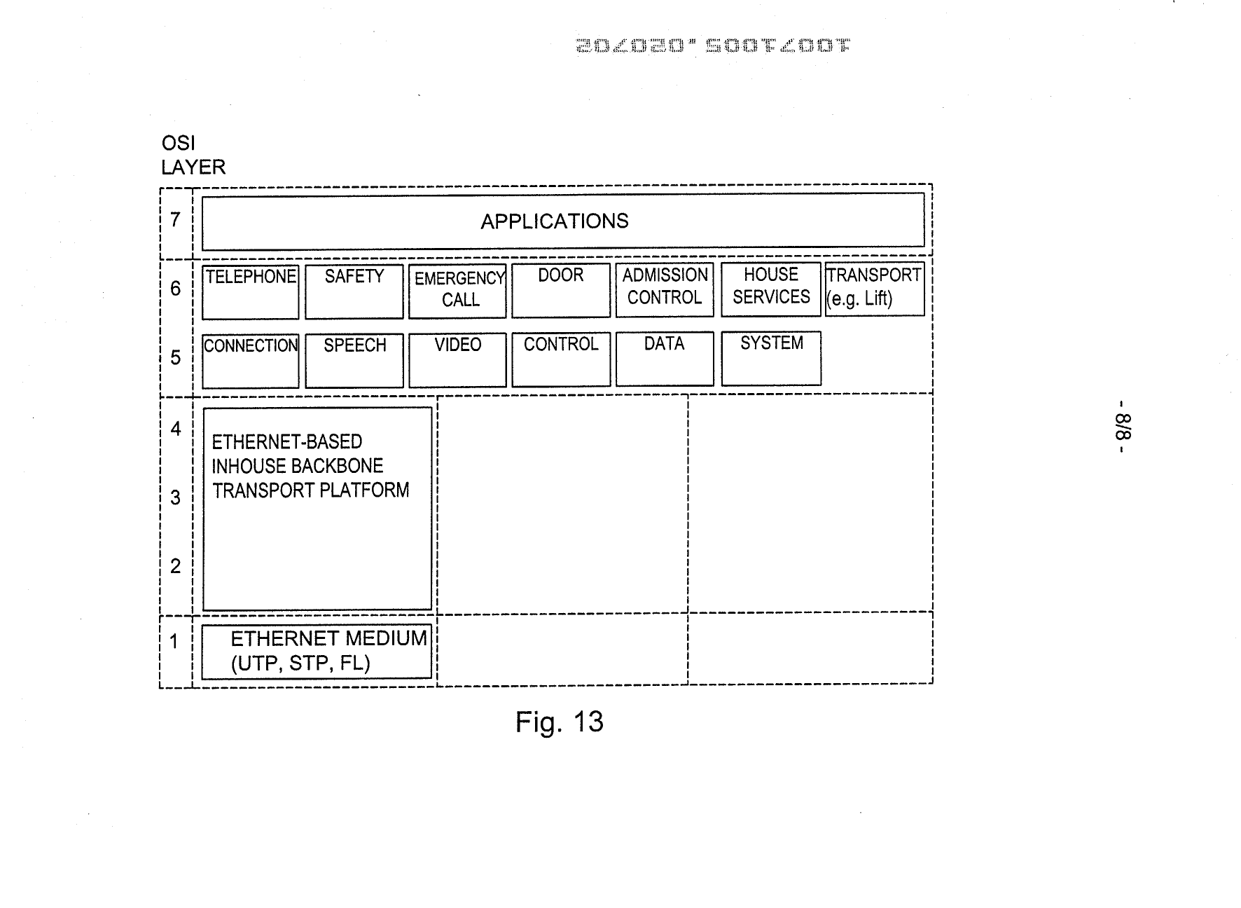

FIG. 13 shows an overview over the classification of the individual services in a protocol stack using the ISO-OSI model. In the left-hand column of FIG. 13, the OSI layer numbers are numbered from 1 to 7. The lowest layer 1 refers to the Ethernet medium, which may include a UTP (UTP=Unshielded Twisted Pair), a STP (STP=Shielded Twisted Pair) or an FL (FL=Fibre Link) or any other medium. The layers 2 to 4 from FIG. 13 relate to the in-house data bus transport platform. Layer 5 includes basis communication services. The connection service relates to the transmission of connection information. The voice service relates to the transmission of voice data. The video service relates to the transmission of video data. The control service relates to the transmission of control data. The data service relates to the general data transmission, for example, WWW or FTP. The system service finally relates to the transmission of system-specific information.

The extended in-house services are set forth in layer 6. The telephone service relates to voice communication, telephony and video telephony. The safety service relates to safety functions, for example, an alarm system. The emergency call service relates to an emergency call or an alarm. The door service relates to door communication. The admission control service relates to the admission control for the house, or rather, for the separated blocks of buildings. The house-services service relates to facility management, such as, for example, water, electric light, etc. The transport service relates to in-house transport systems, such as, for example, lifts, escalators, etc.

The individual application provided by the communication devices located in the terminal units are located in top layer number 7.

In summary, the advantages of the inventive communication network in addition to the inventive individual components, such as transport platform and intelligent network terminating device are, once again, specified:

The intelligent network terminator (NT) integrates various communication systems (DECT, Ethernet, ISDN, in-house bus system) and enables interworking between various interfaces. The NT works as a central distributor within a unit (e.g., flat or room).

The Ethernet transport platform is based on a standardised, flexibly extendable in-house broad-band transmission procedure with the support of 10 to 1000 Mbits/s (shared medium or rather point to point) as in-house back-bone. In special cases, other transmission procedures/protocols may be employed (for example, Powerline, SDSL, Wireless-LAN) using relatively simple adaptations.

The communication system is, at the same time, a transport and service platform (service-transparent and/or service-specific transmission).

It is possible to include typical house-services (door and house communication, safety, building control, monitoring services, specialised applications, such as, for example, Concierge, . . . .

In contrast to the individual interfacing of each subscriber/flat, a concentrating interfacing to the access network via narrow-banded and broad-banded access systems (ISDN, BK, xDSL; Powerline, Fiber . . . ) is provided. This may be implemented at a reasonable price, since it is possible to utilise the multiplex gain.

The inventive concept further provides a considerable savings potential in terms of cabling, management and also in terms of the devices which are used owing to multiple usage. This results in additional cost saving by the multiplex gain when accessing the access network (telecommunication and Internet), so that, for example, a house can be networked on a broad-band basis via only one twisted two-wire line (for which rent has to be paid to the Deutsche Telekom).

A multi-medial terminal device permits access to the interfaces integrated within the intelligent network terminating device (NT=Network Terminator) and enables communication and information processing within a building. The multi-functional terminal device can replace, or rather, supplement previous terminal devices.

Digressing from the preferred embodiments previously described, it should be appreciated that, for the central data bus, also alternative networks, such as, for example, xDSL or PLC (PLC=Power Line Communications) can be employed in addition to the Ethernet. If such a network has already been provided with a specific access control, for example, a stochastic access control, which operates independently of the inventive QoS function, such a network will not be used. Instead, access will be controlled by the inventive QoS function.

Furthermore, it should be appreciated that the Ethernet is preferred as a central data bus. However, if another network should be more favourable in price owing to marginal conditions, for example, by utilising an already existing infrastructure, the same will be preferred in this special case.

1. Communication network for a house, a flat or an office in a house or for separated blocks of buildings, so as to connect at least three terminal units within the house, the flat, the office or the separated blocks of buildings, comprising:
a central data bus for transmitting data to be transmitted between at least the said three terminal units;
a first network terminating device which is provided for a first terminal unit and which comprises interfaces for communication devices which may be disposed in the first terminal unit;
a first interface which is allocated to said first network terminating device and which is disposed between the central data bus and the first network terminating device and which is designed for controlling an access of the first network terminating device to the central data bus;
a second network terminating device, which is provided for a second terminal unit and which comprises interfaces for communication devices which may be disposed in the second terminal unit;
a second interface which is allocated to the second network terminating device and which is disposed between the data bus and the second network terminating device and which is designed for controlling an access of the second network terminating device to the central data bus;
a third network terminating device which is provided for a third terminal unit and which comprises interfaces for communication devices which may be disposed in the third terminal unit;
a third interface which is allocated to the third network terminating device and which is disposed between the central data bus and the third network terminating device and which is designed for controlling an access to the third network terminating device on the central data bus,
wherein the central data bus is a jointly utilised transmission path which may be accessed by the first, second or third network terminating device without considering other network terminating devices,
wherein said first, second and third interface are arranged for controlling said access to the first, second and third network terminating device on the central data bus such that guaranteed transmission parameters are guaranteed for a communication between the first, the second and the third network terminating device via the central data bus, and
wherein each network terminating device or each communication device connected to the network terminating device is formed so as to arrange, together with the interface which has been allocated to the same, transmission parameters for a transmission via the central data bus for achieving an adaptive service quality.

2. Communication network according to claim 1, wherein the central data bus is an Ethernet network as per standard IEEE 802.3, a PLC network, an xDSL network, a broad-band cable network or a broad-band radio network.

3. Communication network according to claim 1, wherein the interfaces of said first, second or third network terminating device comprise an interface selected from the following group: interface for a broad-band radio system for transmitting voice and/or data, an interface for an Ethernet system, an interface for an ISDN system, an interface for a POTS system, an interface for a sensor/actor system for a house control, an interface for a sensor/actor system for a house monitoring system, an interface for a PLC system, an interface for a system for door communication and an interface for an EIB system.

4. Communication network according to claim 1, wherein said first network terminating device is formed as a central information and communication server and which further includes an interface for an external communication system so as to permit a voice and data communication connection between the communication devices connected to the network terminating devices and a subscriber of the external communication system.

5. Communication network according to claim 4, wherein the interface for the external communication system is an ISDN interface, a broad-band xDSL interface, an interface for a terrestrial broad-band radio system, a satellite radio system, an optical fibre cable, an external PLC network or a broad-band copper cable.

6. Communication network according to claim 1, wherein the data bus is embodied by a non-shielded twisted two-wire line, by a shielded twisted two-wire line, by an optical fibre cable or by a wireless connection.

7. Communication network according to claim 1, wherein at least one network terminating device is formed, so as to enable a communication between the communication devices connected to the interfaces of the same without transmitting data concerning this communication via the central data bus on a broadband basis.

8. Communication network according to claim 1, wherein the bus further comprises:
a trunk section connected to the first network terminating device;
a hub for each network terminating device with the hubs being located in the trunk section; and
a secondary section for each network terminating device, with each network terminating device being able to communicate with the first network terminating device via the secondary section provided for the same and the corresponding hub.

9. Communication network according to claim 1, wherein the interfaces are formed to establish at least one parameter from the group of parameters, which comprises band-width reservation, delay time, periodic transmission, jitter and access control, as a transmission parameter for achieving an adaptive service quality.

10. Communication network according to claim 1, wherein said first and second and, third interface have been arranged so as to implement a centralised or decentralised selection procedure for controlling said access to the data bus.

11. Communication network according to claim 10, wherein the interface are located so as to implement a token-passing procedure or a master/slave procedure.

12. Communication network according to claim 1, wherein the central data bus with respect to its data transmission capacity is scalable on a required data capacity.
